(19) United States
(12) Patent Application Publication
(10) Pub. No.: US 2007/0201066 A1
(43) Pub. Date: Aug. 30, 2007

(54) DENSITY MEASUREMENT, COLORIMETRIC DATA, AND INSPECTION OF PRINTED SHEET USING CONTACT IMAGE SENSOR

(76) Inventor: Asa Ziv, Givataim (IL)

Correspondence Address: SCHWEITZER CORNMAN GROSS & BONDELL LLP, 292 MADISON AVENUE - 19th FLOOR, NEW YORK, NY, 10017, US

(21) Appl. No.: 11/741,029

(22) Filed: Apr. 27, 2007

Related U.S. Application Data
(63) Continuation of application No. PCT/IL05/01130, filed on Oct. 30, 2005.

(51) Int. Cl. H04N 1/60

(52) U.S. Cl. 358/1.9; 358/475; 101/232

(57) ABSTRACT

An image quality measurement apparatus measures quality of an image printed on a substrate. The apparatus comprises illumination elements and image sensors, both mounted in close proximity to the substrate, a controller of the image sensors and illumination elements, and an analyzer of the measurements of the image sensor. The measurements can be used as real time feedback to a printer. The measurements may include density, colorimetric data, and inspection of printed sheet using Contact Image Sensors (CIS).

The present application is a Continuation of PCT/IL2005/001130, filed Oct. 30, 2005, which claims the priority of U.S. Provisional application Ser. No. 60/622,680, filed Oct. 28, 2004.

### FIELD AND BACKGROUND OF THE INVENTION

The present invention relates to printing technology and, more particularly, but not exclusively to quality assessment of printed matter, and, even more particularly, but still not exclusively to the assessment of color quality of the printed image.

In the sheet fed printing process of today, whether it is digital printing or legacy offset printing, gravure printing or flexographic printing, there is a need to assess the quality of the printed image within the printing machine. The prime measure of quality is the quality of the colors of the printed image.

As with any other manufacturing process, the sooner a problem is located the simpler it is and the cheaper it is to correct. Industrial printing is a very fast process and any stoppage is inherently expensive. The best solution is to have a continuous quality assessment with a feedback mechanism that can correct quality drifts on-the-fly, before any stoppage is required.

In any common printing technology, the quality of the printed image is bound to change with time, during the printed job run, for various reasons:

The amount of ink over the substrate varies constantly.

Wear of the Printing Plate

Change of pressure between the printing plate and the surface

Change of ink pressure

Temperature change

Changes of ink viscosity

Change of ink density

Change of balance between the ink and the water

Changes of the quality of the substrate

Obviously, a continuous colorimetric measurement and a resulting modification of the printing calibration such as ink pressure, ink temperature, ink density, water to ink balance, press pressure and other parameters can enhance the color stability and the quality of the printed image.

Furthermore, based on accurate calorimetric measurement it is possible to profile the printing parameters to achieve the best printed image for a certain combination of plate type, substrate type, ink type, etc. Using the adequate profile may considerably decrease the set-up time of a print job run.

The common methods of acquiring colorimetric data for the sheet-fed printing comprise human inspection, Automatic Optical Inspection (AOI), and offline color measurement tables.

Human Inspection

Human inspection is performed by the operator of the printing machine. The operator randomly samples a printed sheet from the press delivery area, and checks the sampled sheet against a proofing sheet. If the operator detects a color change the operator manually manipulates a set of ink keys to correct the color in the designated area.

This method is disadvantageous for the following reasons:

Subjectivity—the result is as good as the operator's capabilities at the time of printing and is therefore variable from person to person, from day to night, and prawn to errors

Delay—the sampling is erratic, it takes the operator 2-3 minutes to pick up a sheet, analyze it and correct the printer settings while the printer is running. It therefore takes hundreds of sheets of low quality image until a problem is rectified.

Instability—as the sheets may be sampled before the colors have stabled it is possible the coloring is fluctuating faster than the sampling and the correction is performed based on inadequate data, which may lead to over correction and deterioration of the quality.

Automatic Optical Inspection Systems (AOI)

Currently available AOI systems are, for example, EagleEye manufactured by ISRA Vision Systems AG, Industriestr. 14, D-64297 Darmstadtand, Germany and installed on a MAN Roland presses (MAN Roland Druckmaschinen AG, Stadtbachstraβe 1, 86153 Augsburg, Germany), and Qualitronic II manufactured by Koenig & Bauer (Koenig & Bauer AG, Würzburg Facility, Friedrich-Koenig-Str. 4, D-97080 Würzburg, Germany). AOI systems employ a commercial CCD or CMOS line scan camera. The camera is typically mounted at an optical distance from the printed surface to capture the entire width of the printed image, while the illuminating fixture is positioned closely to the surface.

This method is disadvantageous for the following reasons:
Difficult to calibrate—the distance between the camera and the imaged sheet complicates the calibration of the optical system. Calibration must be performed each time any optical component is replaced.
Vibration—the large optical distance between the camera and the printed image translates the small vibrations of the press frame into a significant movement of the camera, thus limiting the useful resolution of the camera
Human interference—the optical path crosses the area where the operator stands to control the ink-feeding tower. The operator body and limbs affects the illumination and interfere with the optical path.

Offline Color Measurement Tables

Various offline color measurement solutions are available, such as ROLAND CCI′ (Computer-controlled inking) from MAN Roland Druckmaschinen AG, Stadbachstrasse 1, 86153 Augsburg, Germany, and Prinect Image Control from Heidelberger Druckmaschinen AG, Kurfürsten-Anlage 52-60, 69115 Heidelberg, Germany. These solutions provide an offline scanning of the printed sheet. Offline scanning is similar to human inspection except that it is not subjective and enables and can automatically provide ink keys correction commands.

This method is disadvantageous for the following reasons:
Manual—operator's attention is still required in taking the sheet out of the collector area to the offline scanner.
Delay—the sampling is erratic, it takes the operator 2-3 minutes to pick up a sheet, analyze it and correct the printer settings while the printer is running. It therefore takes hundreds of sheets of low quality image until a problem is rectified.
Instability—as the sheets may be sampled before the colors have stabled it is possible the coloring is fluctuating faster than the sampling and the correction is performed based on inadequate data, which may lead to over correction and deterioration of the quality.
Slow—the available scanners scan the sampled sheet much lower than the speed of the press and even slower than the human eye. It is therefore impossible to use the scanner within the printing machine.
Erroneous—as the method employs densitometers or spectrophotometers with narrow field of view, and does not involve image processing to ignore print imperfections that should not affect the color settings, the method produces correction errors.

WO 2004 022342 teaches method and apparatus for on-line monitoring or print quality achieving good accuracy of measurement using contact imaging sensing, but failing to achieve high resolution and imaging with the equipment disclosed. Higher resolution in contact imaging can only be achieved using small detectors, these collected a relatively small amount of photons in a given period of time, and therefore the accuracy of measurement is limited such as CMOS Contact Image Sensors.

U.S. Pat. No. 5,650,864 teaches a color-reproducing contact image sensing apparatus, but systems that are based on this idea failed to accurately read color values, because of two factors: the embedded color filters does not have the needed separation between the basic colors (Red, Green and Blue), and the of CMOS based sensors have an internal low signal to noise ratio (comparing to CCD based sensors) that limits its dynamic range.

There is thus a widely recognized need for, and it would be highly advantageous to have a system for assessing the quality of a printed image, achieving both high accuracy and high resolution, and devoid of the above limitations.

### SUMMARY OF THE INVENTION

It is an object of the present invention to provide scanning apparatus for indicating the quality of an image while or shortly after said image is being printed by a printer on a substrate. The apparatus comprises an image processor producing a feedback signal indicating the quality of the image, an illuminator illuminating the substrate, an image sensor measuring light emerging from the substrate, producing a plurality of signals, and comprising a plurality of image sensing elements, with each element located in close proximity to the substrate, and each element providing at least one of the plurality of signals to said image processor, such that the value of any of the output signals at a specific time is a representation of a specific element of the image, and collectively said representations form a detected representation of the image. The image processor according to the present invention is operative to lower the resolution of at least one high quality portion of the detected representation and thus increase its accuracy.

It is in the scope of the present invention to provide apparatus as described above wherein the feedback signal comprises calorimetric data

It is also in the scope of the present invention to provide apparatus as described above wherein the image sensing elements are fitted with respective color filters, thereby to provide the colorimetric data.

It is also in the scope of the present invention to provide apparatus as described above wherein the color filters are for three colors.

It is also in the scope of the present invention to provide apparatus as described above wherein the color filters are for at least four colors.

It is also in the scope of the present invention to provide apparatus as described above wherein the image sensing elements comprise CMOS Contact Image Sensor Integrated Circuits.

It is also in the scope of the present invention to provide apparatus as described above wherein the image processor further comprising a color density unit for deriving color density values from the colorimetric data.

It is also in the scope of the present invention to provide apparatus as described above wherein the feedback signal is configured to control at least one member of the group consisting of ink keys, ink water balance, color registration, and press parameters of said printer.

It is also in the scope of the present invention to provide apparatus as described above wherein the close proximity is substantially 5 centimeters or less.

It is also in the scope of the present invention to provide apparatus as described above wherein the printer is at least one of a sheet fed printing apparatus and an offset printing apparatus.

It is also in the scope of the present invention to provide apparatus as described above wherein the image processor further comprises a color analyzer.

It is also in the scope of the present invention to provide apparatus as described above wherein the color analyzer comprises at least one of a color density analyzer and a color registration analyzer.

It is also in the scope of the present invention to provide apparatus as described above wherein the color analyzer comprises an analyzer of at least one of the group consisting of Delta-E, delta-LAB and LAB color measurements, and dot gain, dot area, trapping and gray balance.

It is also in the scope of the present invention to provide apparatus as described above wherein the feedback signals comprises a measure of color and affects the composition of printing colors of the printer.

It is also in the scope of the present invention to provide apparatus as described above wherein the image processor is operative to compare said detected representation with a reference image.

It is also in the scope of the present invention to provide apparatus as described above wherein die reference image is at least one of a computer generated image and a scanned image.

It is also in the scope of the present invention to provide apparatus as described above wherein the image processor comprises an analyzer of at least one of a barcode and a text.

It is also in the scope of the present invention to provide apparatus as described above wherein the image processor comprises an analyzer of at least one of a fixed data and a variable data.

It is also in the scope of the present invention to provide apparatus as described above wherein the image processor is additionally operative to convert the detected representation to a displayable representation of the image.

It is also in the scope of the present invention to provide apparatus as described above wherein the image processor is additionally operative to transmit the feedback: signal to a remote site.

It is also in the scope of the present invention to provide apparatus as described above wherein the outputs of CIS devices are mounted in a single line.

It is also in the scope of the present invention to provide apparatus as described above wherein the single line comprises a plurality of triplets of red, green and blue sensors.

It is also in the scope of the present invention to provide apparatus as described above wherein the outputs of CIS devices are mounted in two parallel lines.

It is also in the scope of the present invention to provide apparatus as described above wherein the two lines comprise a first line comprising a plurality of a first pair of color sensors and a second line comprising a plurality of a second pair of color sensors, the second pair being different from said first pair, the first and second pairs being selected from red, green and blue sensors.

It is another object of the present invention to provide a method of measuring quality of a printed image, while or shortly after it is being printed, said method comprising a step of illuminating the image at close proximity, a step of measuring light reflected from the image at close proximity, a step of forming a detected representation of the image, and a step of analyzing the detected representation to form a quality analysis, wherein the step of analyzing comprises lowering the resolution of at least one high quality portion of the detected representation and thus increasing its accuracy.

It is in the scope of the present invention to provide a method of measuring quality of a printed image as described above, wherein the close proximity is 5 centimeters or less.

It is also in the scope of the present invention to provide a method of measuring quality of a printed image as described above, additionally comprising a step of providing the quality analysis as a feedback to a printing apparatus.

It is also in the scope of the present invention to provide a method of measuring quality of a printed image as described above, wherein the steps of measuring and analyzing comprises measuring and analyzing color of the image.

It is also in the scope of the present invention to provide a method of measuring quality of a printed image as described above, wherein the step of analyzing color comprises analyzing at least one of a color density and a color registration.

It is also in the scope of the present invention to provide a method of measuring quality of a printed image as described above wherein the step of analyzing color comprising analyzing at least one of Delta-E, delta-LAB and LAB color measurements.

It is also in the scope of the present invention to provide a method of measuring quality of a printed image as described above, wherein the step of providing feedback affects composition of printing colors of the printing apparatus.

It is also in the scope of the present invention to provide a method of measuring quality of a printed image as described above, wherein the feedback affects at least one of calibration of ink keys and calibration of color registration.

It is also in the scope of the present invention to provide a method of measuring quality of a printed image as described above wherein the step of analyzing comprises comparing the detected representation with a reference image.

It is also in the scope of the present invention to provide a method of measuring quality of a printed image as described above, wherein the step of comparing comprises comparing the detected representation with at least one of a computer-generated image and a scanned image.

It is also in the scope of the present invention to provide a method of measuring quality of a printed image as described above, wherein the step of analyzing comprises analyzing at least one of a barcode and a text.

It is also in the scope of the present invention to provide a method of measuring quality of a printed image as described above, wherein the step of analyzing comprises analyzing at least one of a fixed data and a variable data.

It is also in the scope of the present invention to provide a method of measuring quality of a printed image as described above, wherein the step of analyzing comprises displaying said measurement of light.

It is also in the scope of the present invention to provide a method of measuring quality of a printed image as described above, additionally comprising a step of sending at least either a measure of light or a measure of quality to a remote site.

The term ‘contact image sensors’ refers in the present invention to sensors that are not actually placed in contact with the substrate, since they are optical devices and are able to scan without being in contact. The sensors are able to scan from distances in the order of magnitude of tens of centimeters and from further away if suitable optics is provided.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of an image quality measurement apparatus 110 mounted within a sheet-fed printer system 11 according to a preferred embodiment of the present invention

FIG. 2 is a simplified drawing of the quality measurement apparatus of FIG. 1 according to a preferred embodiment of the present invention.

FIG. 3 is a simplified drawing of another view of the quality measurement apparatus of FIG. 1 according to a preferred embodiment of the present invention.

FIG. 4 and FIG. 5, are simplified illustrations of two configurations of the array of image sensors, according to a preferred embodiment of the present invention.

FIG. 6 is a simplified block diagram of an image processing part of the quality measurement apparatus according to a preferred embodiment of the present invention.

FIG. 7 is a simplified block diagram of a process executed by the quality measurement apparatus, according to a preferred embodiment of the present invention.

FIG. 8 is a simplified block diagram of a program executed by the data processing module, according to a preferred embodiment of the present invention

### DESCRIPTION OF THE PREFERRED EMBODIMENTS

The present embodiments enable high-speed, high-resolution imaging of a sheet within a sheet-fed offset press, and to use this imaging to assess the quality of the printed image. Particularly, the present embodiments provide information about optical densities, color composition, color registration, etc. Furthermore, the present embodiments provide information regarding the image quality in real-time, to analyze this information and to produce feedback to the printing machine so as to correct drifts in image quality without stopping the printer or decreasing the printing speed. The present embodiments implement illumination elements and light sensors in close proximity to the printed surface and use for this purpose an array of Contact Image Sensors (CIS). Preferably the sensors are connected in parallel so as to output information at high speed and allow real time processing, and the information is fed back to the printing machine to change settings as necessary.

Consequently, the preferred embodiments confer the following features:
Automation—a printed image quality control system that measures, analyses and controls the relevant settings of the printing machine without human intervention.
Continuity—a printed image quality control system that inspects every single printed sheet and determines color drifts and color fluctuations.
Integration with the printing machine—a printed image quality control system that is integrated into the cavities of a printing machine.

Minimal optical distance—a printed image quality control system that has a minimal distance betveen the sensor and the printed sheet is able to minimize the effect of vibrations in reducing measurement accuracy.
The preferred embodiments use Contact Image Sensor (CIS) chips to provide colorimetric data
The preferred embodiments connect the CIS chips to the control circuitry in parallel, rather then serially. The parallel connection allows high speed data output and consequently enables sampling of the sheet at full printing speed in the highest possible resolution.

The printed image quality control system as described hereinafter may be used for other than sheet-fed offset presses.

The principles and operation of a printed image quality control system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

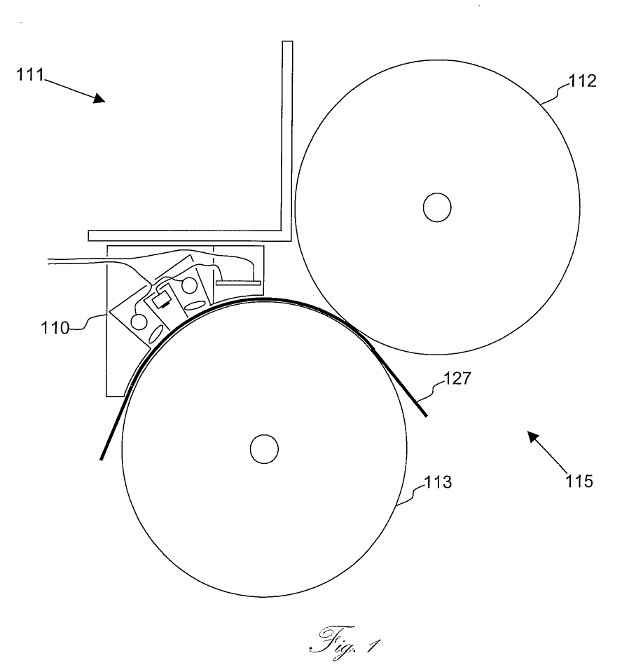

Reference is no made to FIG. 1, which is a simplified illustration of an image quality measurement apparatus 110 mounted within a sheet-fed printer system 111.

As shown in FIG. 1, the printer 111 consists of a printing drum 112 and an impression drum 113. Typically the printing drum 112 carries the ink bearing the image to be printed and transfers the ink onto a sheet 127, which is mounted on the impression drum 113. The printing drum 112 and the impression drum 113 are termed herein a drum system 115. Typically, the drum system 115 described and shown in FIG. 1 prints only one color. A multi-color sheet-fed printing system thus incorporates several drum systems 115 as shown in FIG. 1, each printing a single color, and the sheet is transferred sequentially between the drum systems 115. In this case of a printing system comprising several drum systems 115 the drum system of FIG. 1 is typically the last drum system. It is appreciated that though the quality measurement apparatus 110 is preferably mounted within the last drum system 115, the quality measurement apparatus 110 can be mounted also within other drum systems 115 of the printer system 111.

In some printing systems there may be a third drum, not shown in FIG. 1, typically named an image drum, on which the image is first created by ink applying devices. The ink is then transferred onto a blanket covering the printing drum, and hence onto the sheet mounted on the impression drum. Some printing systems may print several colors within a single drum system.

It is noted that drum-based printing is merely given as an example, and the scanner of the present embodiments is relevant for any kind of printing in which output quality measurements can be fed back to alter printer settings. This includes any kind of color printer.

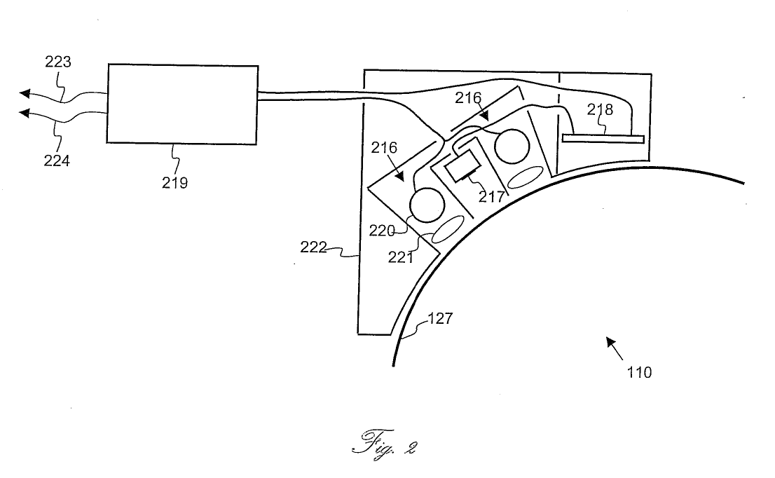

Reference is now made to FIG. 2, which is a simplified drawing of the quality measurement apparatus 110 of FIG. 2 according to a preferred embodiment of the present invention. The quality measurement apparatus 110 preferably consists of illumination elements 216, image sensors 217, a data compression board 218 and a data processing unit 219. The illumination element 216 typically consists of a lamp 220 and an optical system such as a lens 221. The lamp 220 can be any type of lamp such as incandescent lamp, fluorescent lamp, light emitting diode (LED), Cold Cathode Fluorescent Lighting (CCFL), Metal Halide, etc. The optical system can be, for example, a lens or a light guide such as a Fiber optic.

The illumination element 216, the image sensors 217 and the data compression board 218 are preferably mounted within a frame 222 of the printing system 111. The illumination element 216 and the image sensors 217 are preferably mounted in close proximity to the printed sheet which is located on surface 127. Preferably the image sensors 217 are mounted 5 centimeters from the printed surface or closer.

The data compression board 218 is preferably mounted in close proximity to the image sensors 217.

Typically and preferably the illumination element 216 and the data compression board 218 are connected to the data processing unit 219. The data processing unit 219 preferably comprises various communication facilities, such as control link 223 connected to the printer controller and display link 224 connected to various display units. It is appreciated that the quality measurement apparatus 110 is capable of providing a displayable scan of the printed image, to be displayed on a display unit, preferably via the display link 224. It is also appreciated that such display units can be co-located with the printing system 111 or located remotely from the printing system 111. Image sensors 217 are CMOS contact image sensor integrated circuits.

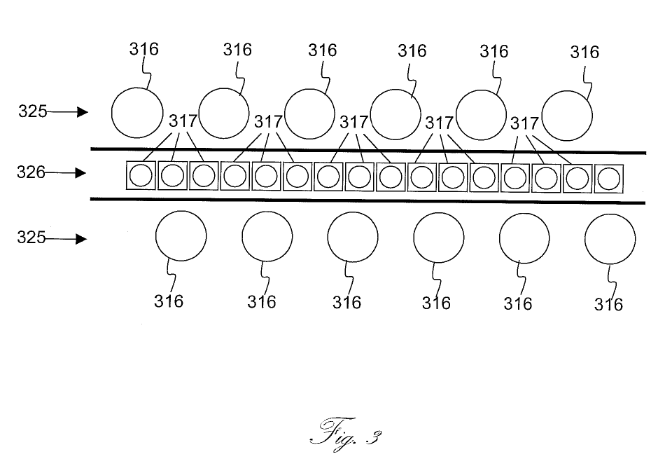

Reference is now made to FIG. 3, which is a simplified drawing of another view of the quality measurement apparatus 110 of FIG. 1 according to a preferred embodiment of the present invention.

As shown in FIG. 3, typically and preferably the illumination elements 216 of FIG. 2 are two arrays 325 of illumination elements 316 and the image sensor 217 of FIG. 2 is an array 326 of image sensors 317.

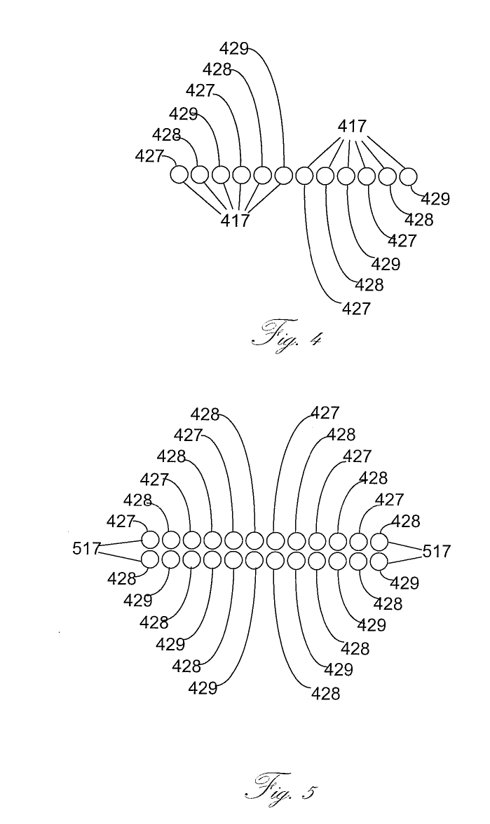

Reference is now made to FIG. 4 and FIG. 5, which are simplified illustrations of two configurations of the array 326 of image sensors 317, according to a preferred embodiment of the present invention.

As shown in FIG. 4, the array 326 consists of a single line of image sensors 417. The image sensors 317 of FIG. 3 are preferably arranged in a single row sequence of elements:

R G B R G B R G B R G Y B

where the R image sensor element 427 senses red, the G image sensor element 428 senses green, and the B image sensor element 429 senses blue. Typically and preferably the image sensors 317 are equipped with R, G and B filters.

Alternatively, as shown in FIG. 5, the array 326 consists of single line of image sensors 517. The image sensors 317 of FIG. 3 are preferably arrange in a dual row format (Bayer filters:)

R,G,R,G,R,G,R,G,R

G,B,G,B,G,B,G,B,G

Typically and preferably, each image sensor 317 senses a single picture element (pixel)

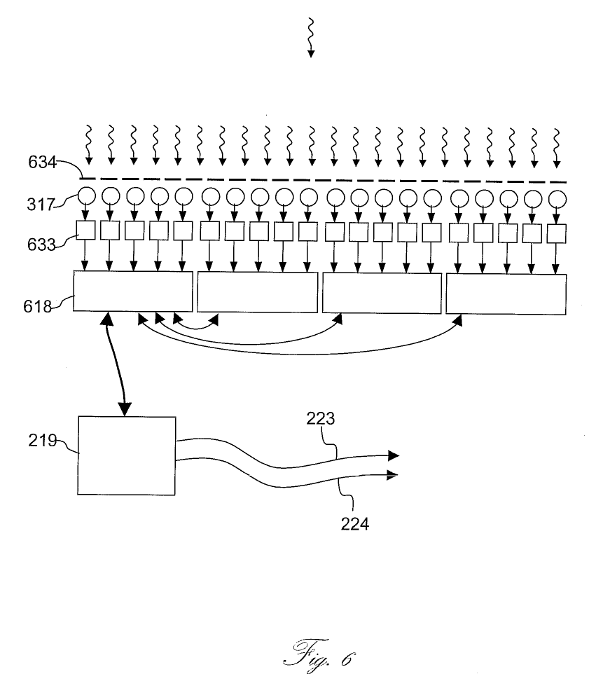

Reference is now made to FIG. 6, which is a simplified block diagram of an image processing part of the quality measurement apparatus 110 according to a preferred embodiment of the present invention.

As shown in FIG. 6, the image processing part of the quality measurement apparatus 110 consists of the array 326 of image sensors 317, an array of analog-to-digital converters (ADC) 633, an array of the data reduction modules 618, and the data processing module 219. As shown in FIG. 6, each image sensor 317 is preferably equipped with a color filter 634. Preferably the color filters are red, green and blue filters (RGB) as described above with reference to FIGS. 4 and 5.

As shown in FIG. 6, each image sensor 317 is preferably connected to an ADC 633, which converts the analog measurement of the image sensors 317 into a digital signal. The ADC 633 is preferably connected to a data reduction module 618, which receives the digital signals, compresses and multiplexes them, and sends the signals in a continuous bit stream to the data processing module 219. Preferably the data reduction modules 618 are daisy-chained as shown in FIG. 6. The data processing module 219 typically and preferably comprises various communication facilitates, such as control link 223 connected to the printer controller and display link 224 connected to various display units.

It is appreciated that the output from the CIS chip can be either analog or digital. FIG. 6 illustrates CIS chips with analog outputs.

It is appreciated that the front CIS chips can be single chips or a device comprising several CIS sensors.

It is appreciated that the digital connection between the CIS chips and the data compression board are preferably implemented using standard communication technologies such as camera link, USB2, RS485, Ethernet or similar high speed communication technologies.

It is appreciated that the data compression boards preferably implement binning and ROI (region of interest) functions to reduce the amount of data to be transferred to the processing unit. These functions are preferably implemented simultaneously for each frame, or separately, different from frame to frame.

It is appreciated that the digital connection between the data reduction board and the processing unit is preferably implemented in standard communication technologies such as camera link, USB2, RS485, Ethernet or any other high speed communication technologies.

It is appreciated that scanning images in high resolution and in high printing speed creates a large quantity of data to be processed. For example, a 40″×30″ sheet scanned at 400DPI at 3 colors (R,G,B) and at 12 bits per pixel at the printing speed of 18,000 sheets per hour generate a bit stream of 36 G bits/Second. Therefore the bit stream is preferably compressed before it is transferred to the processing unit. The reduction unit performs the following steps:

Compensate for Fixed Pattern and other noises;

Designate lower scanning resolutions to areas of lower interest;

Designate lower scanning bit depth to areas having lower color interest

Apply selective Gamma corrections, converting pixel sampling from 12 bits to 8 bits through Gamma function conversion

Designating lower scanning resolutions to areas of lower interest achieves high measurement accuracy, where high resolution is not required, for example when measuring color patches that are uniform in color and important for color management or control. This can be done by any method known in the art, even simple averaging.

Designating lower scanning bit depth to areas having lower color interest achieves high resolution where high measurement accuracy is not required, for example in reading black & white text or line art. This is done by refraining from any spatial averaging

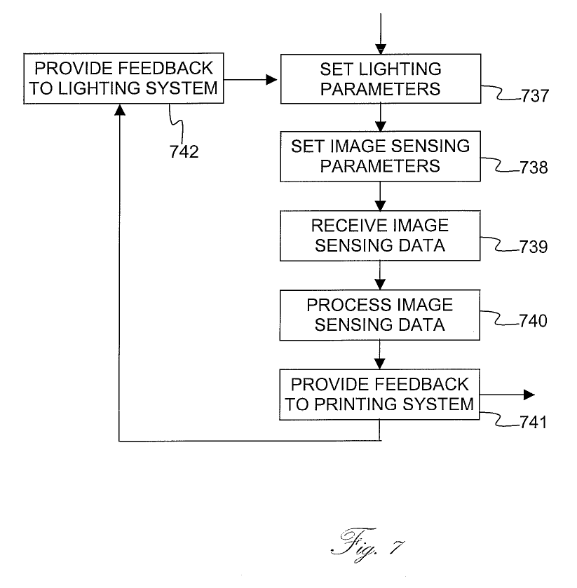

Reference is now made to FIG. 7, which is a simplified block diagram of a process executed by the quality measurement apparatus 110, according to a preferred embodiment of the present invention.

As shown in FIG. 7, the process starts with step 737, by setting the parameters of the illumination elements 216 and proceeds to step 738 to set the parameters of the image sensors 217, according to the characteristics of the printed image. The process than proceeds to step 739 to receive image data from the image sensors 217 and then to step 740 to process the image data, as will be explained below in further details. The results of the processing of step 740 are provided in step 741 as feedback, either manually or automatically, to the printing system 111. The results of processing of step 741 are also provided in step 742 as feedback to the illumination elements 216 and preferably also to the image sensors 217.

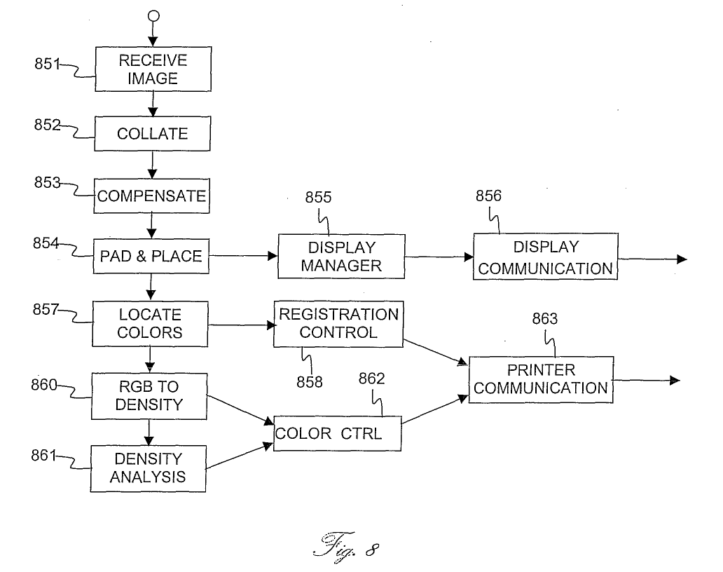

Reference is now made to FIG. 8, which is a simplified block diagram of a program executed by the data processing module 219, according to a preferred embodiment of the present invention.

As shown in FIG. 8; the program executed by the data processing module 219 preferably consists of 12 modules:

Receive Image module 851

Collate module 852

Compensation module 853

Pad and Place module 854

Display Manager module 855

Display Communication module 856

Locate Colors module 857

Registration Control module 858

RGB to Density Conversion module 860,

Density Analysis module 861

Color control module 862

Printer Communication module 863

The Receive image module 851 receives the pixel bit stream from the reduction units or compression boards 218, and performs the following functions:

Identify a sheet image block;

Identify image type;

Calibrate the color bar;

Calibrate viewing;

Calibrate lighting reference;

Identify the sheet number;

Calibrate the physical position;

Calibrate the pixels' positions;

Calculate a binning factor;

Calculate de-gamma compensation, preferably to 12 bit; and

Transmit the processed sheet image and its associated parameters to the Collate module.

The Collate module 852 collects images from the same sheet and the same type and transfers the data, comprising the collection of sheet images, to the compensation module 853.

The compensation module 853 process the sheet's collection of images to provide compensation for the following artifacts:

Dark signal resulting from fixed pattern noise;

White non-uniformity resulting from variations between sensors;

White non-uniformity resulting from illumination non-uniformity;

Light level from light reference;

Chromatic aberrations.

The compensation module then transfers the compensated data to the Pad and Place module 854. The above operation is used to compensate for positioning errors that may have occurred during the physical butting of image sensors 217. More particularly, when a pixel is missing or moved due to sensor positioning errors, padding and placing algorithms are used to compensate for the missing pixel.

The Pad and Place module 854 relocates the pixel information to create an image of equally spaced pixels. The Pad and Place module 854 then transfers the image data to the Display Manager 855, which reformats the image for the target display and transfer the reformatted image to the Display Communication module 856 to be transmitted to a local display, or to a remote display (or both). The Pad and Place module 854 also transfers the image data to the Locate Colors module 857.

The Locate Colors module 857 identifies and locates color patches within the sheet image and transfers this information to the Registration Control module 858 and to the RGB to Density Conversion module 860.

The Registration Control module 858 processes the image information, generates registration correction data, and transfers this data to the Printer Communication module 863.

The RGB to Density Conversion module 860 converts the RGB signals into color density parameters and transfers these parameters to the Density Analysis module 861 and to the color control module 862.

The Density Analysis module 861 analyses the changes in density values, preferably both the temporal and the spatial changes, generates density trend parameters and sends them to the color control module 862.

The color control module 862 processes the density parameters received from the ROB to Density Conversion module 860 and the density trend parameters received from the Density Analysis module 861 and produces ink-key correction parameters, which it sends to the Printer Communication module 683.

The Printer Communication module 863 transmits the registration correction parameters and the ink-key correction parameters to the printer system 111 to compensate for drifts in the image quality. Thus the image quality is corrected in real-time and without affecting the printing speed.

Alternatively, if the printer system 111 is not equipped to receive feedback signals, the registration correction parameters and the ink-key correction parameters are provided to an operator of the printer system 111 so that he may carry out manual modification of the settings of the printer system 111.

Thus the present embodiments enable high-speed and high resolution imaging of a sheet inside a sheet-fed offset press and as an integral part of the printing process. The present embodiments further use this imaging data to provide:

Optical density measurements;

Color measurements;

Inspection of print quality;

Color registration analysis; and

Other optional information.

Preferably, the present invention uses Contact Image Sensor (CIS) chips for its image sensors 217. The use of CIS technology enables a faster scanner and a smaller scanner. Preferably the present embodiments can be mounted within a common sheet-fed offset press.

It is appreciated that the present embodiments can be used for printing systems other than sheet-fed offset printers.

The image sensors 217 preferably consist of Contact Image Sensor (CIS) chips that are preferably physically butted to each other to create a sensor of a preferred length.

Preferably, to enable fast scanning of the image, the image sensors 217 are operated simultaneously. As described with reference to FIG. 7, the outputs of the CIS chips are preferably connected in parallel, rather than in daisy-chain configuration, to enable higher clock rates and to provide faster sampling rate, thus supporting imaging of the printed sheets at full printing speed and in the highest resolution required

Color filters 634 are preferably mounted on the image sensors 217 (preferably CSI devices), preferably in a single line or a dual line configurations as described with reference to FIGS. 5 and 6. As described with reference to FIG. 7, the outputs of the CIS devices are preferably connected in parallel, rather than in daisy-chain configuration, to enable higher clock rates and to provide faster sampling rate, thus supporting imaging of the printed sheets at full printing speed and in the highest resolution required.

The RGB information taken from each group of three CIS devices in single row format (or a group of four CIS devices in dual rows format) is converted to density information as described below. Alternatively, the ROB information is converted into XYZ values and then to LAB values to create Delta-E and LAB information readouts

Preferably the CIS devices are calibrated in the manufacturer's laboratory and all artifacts and differences between pixels and chances over time are rectified in real-time during operation, using the information created during the calibration procedure. The calibration procedure preferably includes the following steps:

Measure the flat-field correction needed (differences between pixels)

Adjust RGB gains and offsets

Calibrate the responsiveness and light energy with an optical reference

Measure the spectral response of the sensor

Measure the spectral energy of the light source

Alternatively, use an ICC profile of the scanner to achieve calorimetric data.

The extraction of density values from the RGB measurements is possible when the spectrophotometric response of the sensor and the spectrum of the radiated light are known. A preferred method for converting RGB values to density values is as follows:

The RGB outputs for a specific substrate are:

$$R = {\sum }_{λ = 400}^{700} r ( λ ) * S ( λ ) * β ( λ )$$

$$G = {\sum }_{λ = 400}^{700} g ( λ ) * S ( λ ) * β ( λ )$$

$$B = {\sum }_{λ = 400}^{700} b ( λ ) * S ( λ ) * β ( λ )$$

S is the illumination function;

β is the substrate color function; and

R, G and B are the response functions of the image sensor.

The R, G and B functions are preferably integrals over the visible light, preferably estimated using 32 or 64 points, preferably every 5 or 10 nanometers.

The RGB functions are preferably written as a matrix equation as follows:

$$[ \begin{matrix}R \\ G \\ B\end{matrix} ] = [ \begin{matrix}{r}_{1} … {r}_{n} \\ {g}_{1} … {g}_{n} \\ {b}_{1} … {b}_{n}\end{matrix} ] [ \begin{matrix} \\ \\ s \\ ⋮ \\ \end{matrix} ] [ \begin{matrix} \\ \\ {β}_{1} \\ \\ \end{matrix} ]$$

Similarly and preferably, for a standard, theoretical CMYK sensor:

$$[ \begin{matrix}C \\ M \\ Y \\ K\end{matrix} ] = [ \begin{matrix}{c}_{1} … {c}_{n} \\ {m}_{1} … {m}_{n} \\ {y}_{1} … {y}_{n} \\ {k}_{1} … {k}_{n}\end{matrix} ] [ \begin{matrix} \\ \\ A \\ ⋮ \\ \end{matrix} ] [ \begin{matrix} \\ \\ {β}_{1} \\ \\ \end{matrix} ]$$

A is the standards, illumination type (CGATS standards);

c,m,y,k are the “ANSI status T (or A, E or I)” standard responses;

The above matrices are preferably solved to produce the CMYK value from the known response matrices of the light and the sensor, and the RGB values, as follows:

$$[ \begin{matrix}C \\ M \\ Y \\ K\end{matrix} ] = [ \begin{matrix}{c}_{1} … {c}_{n} \\ {m}_{1} … {m}_{n} \\ {y}_{1} … {y}_{n} \\ {k}_{1} … {k}_{n}\end{matrix} ] [ \begin{matrix} \\ \\ A \\ ⋮ \\ \end{matrix} ] [ \begin{matrix}R \\ G \\ B\end{matrix} ] = {{[ \begin{matrix}{r}_{1} … {r}_{n} \\ {g}_{1} … {g}_{n} \\ {b}_{1} … {b}_{n}\end{matrix} ]}^{- 1} [ \begin{matrix} \\ \\ s \\ ⋮ \\ \end{matrix} ]}^{- 1}$$

Alternatively, the measured spectrum of the illumination is used, together with the measured spectrophotometric response, providing prediction of the RGB values to be measured by the sensor, for each combination of (=380 to 740 in 5 or 110 nanometer steps).

Further alternatively, the CMYK values are predicted using the standard T (or A, E or I) functions and type A illumination parameters. Having multiple pairs of CMYK and RGB vectors from the same color sample, the following K matrix is solved:

$$[ \begin{matrix}C \\ M \\ Y \\ K\end{matrix} ] = [ \begin{matrix}{k}_{1 , 1} … {k}_{1 , 3} \\ {k}_{2 , 1} … {k}_{2 , 3} \\ {k}_{3 , 1} … {k}_{3 , 3} \\ {k}_{4 , 1} … {k}_{4 , 3}\end{matrix} ] [ \begin{matrix}R \\ G \\ B\end{matrix} ]$$

For example by using the Generalized minimal error method (GMERR method) from the known RGB and CMYK values.

The quality measurement apparatus 110 preferably enables the imaging of the entire sheet to provide the following functions (in addition to measurement of color density):
Print defects inspection—comparing the printed image with a scanned proofing image;
Digital proofing—comparing the printed image with a computer generated proofing image;
Variable data verification—comparing selected areas of the printed image with variable data retrieved from a database, checking for the correctness of the variable data, registration to the regular, fixed print, existence of all variable data elements, etc.
Extracting Delta-E, delta-LAB, LAB values and any color information from the RGB information of the sensor,
Barcode inspection—validating the printed barcode information and grading it according to ANSI (grades A,B,C,D or F) or DIN (grades 1, 2, 3, 4 or 0) standards;
Character reading;
Remote proofing—transferring the image for verification to a remote site.

It is appreciated that any press, sheet-fed or web-fed, using offset, flexo, gravure, letterpress or any other technology, conventional press or digital press, is appropriate for mounting the quality measurement apparatus 110. Integrating the quality measurement apparatus 110 into a printing system provides:
Illuminating and sensing of the printed image at close proximity;
Mechanical stability ensuring long term calibration of the optical system;
Reduce energy consumption due to shorter optical distances;
Minimal modifications of the printing system due to the small size of the quality measurement apparatus 110;
Mapping the spectral response of the CIS based sensor enables measuring the colorimetric data of the scanned image for CMYK, or LAB values.
Density reading enables continuous and automatic control of ink-keys, ink-to-water balance and other printer parameters that affect color reproduction.

It is appreciated that the use of the quality measurement apparatus 110 enables approving of the print job without physically visiting the print shop to verify the printed image visually. Having a reliable and accurate reading of the colors from the printed material while in the press, and furthermore having a reliable and accurate verification and correction of text and variable images, enables the printing customer to rely on the digital data and approve the print job from a remote location.

It is appreciated that the use of the quality measurement apparatus 110 enables inspection for process control by comparing the printed image with a required standard image (proofing image, master image). The proofing images are preferably obtained from the pre-press design or by scanning an approved sheet. When detecting a faulty image the quality measurement apparatus 110 preferably sends an alarm to an operator of the printing system, preferably indicating the detected defect. When the current image is different from the proofing image the differences are analyzed and compared against a pre-defined or user defined threshold to reduce false alarms. The detected defects are also analyzed for their type and origin, to assist the operator in resolving the problem. It is appreciated that such inspection can be performed by sampling sheets, since print defects tend to build up slowly.

It is appreciated that some functions of the quality measurement apparatus 110 can be processed using relatively low resolution, thus requiring lower processing power, and therefore can be performed continuously for each sheet. Hence defective sheets may be prevented from reaching the final customer. It is appreciated that this screening process can be performed on-line or offline in a post-printing process.

In a further embodiment of the present invention the contact image sensors may be located in non-contact relation with the sheet or other print substrate. That is to say the image sensors are removed a short distance away from the sheet.

It is expected that during the life of this patent many relevant printing systems old image sensing devices will be developed and the scope of the terms herein, particularly of the terms “Offset”, “Gravure”, “Flexographic” and “CIS”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Scanning apparatus for indicating the quality of an image while or shortly after said image is being printed by a printer on a substrate, said apparatus comprising:
a. an image processor producing a feedback signal indicating the quality of said image;
b. an illuminator illuminating said substrate;
c. an image sensor measuring light emerging from said substrate, producing a plurality of signals, and comprising a plurality of image sensing elements, each element located in close proximity to said substrate, and each element providing at least one of said plurality of signals to said image processor, such that the value of any of said output signals at a specific time is a representation of a specific element of said image, and collectively said representations form a detected representation of said image;
wherein said image processor is operative to increase the accuracy of at least one high quality portion of said detected representation by lowering its resolution.

2. Apparatus according to claim 1 wherein said feedback signal comprises colorimetric data.

3. Apparatus according to claim 2 wherein said image sensing elements are fitted with respective color filters, thereby to provide said colorimetric data.

4. Apparatus according to claim 3, wherein said color filters are for three colors.

5. Apparatus according to claim 3, wherein said color filters are for at least four colors.

6. Apparatus according to claim 1, wherein said image sensing elements comprise CMOS Contact Image Sensor Integrated Circuits.

7. Apparatus according to claim 2, wherein said image processor further comprising a color density unit for deriving color density values from said colorimetric data.

8. Apparatus according to claim 1, wherein said feedback signal is configured to control at least one member of the group consisting of ink keys, ink water balance, color registration, and press parameters of said printer.

9. Apparatus according to claim 1, wherein said close proximity is substantially 5 centimeters or less.

10. Apparatus according to claim 1, wherein said printer is at least one of a sheet fed printing apparatus and an offset printing apparatus.

11. Apparatus according to claim 1, wherein said image processor further comprises a color analyzer.

12. Apparatus according to claim 11, wherein said color analyzer comprises at least one of a color density analyzer and a color registration analyzer.

13. Apparatus according to claim 11, wherein said color analyzer comprises an analyzer of at least one of the group consisting of Delta-SE, delta-LAB and LAB color measurements, and dot gain, dot area, trapping and gray balance.

14. Apparatus according to claim 1, wherein said feedback signal comprises a measure of color and affects the composition of printing colors of said printer.

15. Apparatus according to claim 1, wherein said image processor is operative to compare said detected representation with a reference image.

16. Apparatus according to claim 15, wherein said reference image is at least one of a computer generated image and a scanned image.

17. Apparatus according to claim 1, wherein said image processor comprises an analyzer of at least one of a barcode and a text.

18. Apparatus according to claim 1, wherein said image processor comprises an analyzer of at least one of a fixed data and a variable data.

19. Apparatus according to claim 1, wherein said image processor is additionally operative to convert said detected representation to a displaceable representation of said image.

20. Apparatus according to claim 1, wherein said image processor is additionally operative to transmit said feedback signal to a remote site.

21. Apparatus according to claim 6, wherein outputs of said CIS devices are mounted in a single line.

22. Apparatus according to claim 21, wherein said single line comprises a plurality of triplets of red, green and blue sensors.

23. Apparatus according to claim 6, wherein outputs of said CIS devices are mounted in two parallel lines.

24. Apparatus according to claim 23, wherein said two lines comprise a first line comprising a plurality of a first pair of color sensors and a second line comprising a plurality of a second pair of color sensors, said second pair being different from said first pair, said first and second pairs being selected from red, green and blue sensors.

25. A method of measuring quality of a printed image, while or shortly after it is being printed, said method comprising:
a. illuminating said image at close proximity;
b. measuring light reflected from said image at close proximity;
c. forming a detected representation of said image; and
d. analyzing said detected representation to form a quality analysis;
wherein said step of analyzing comprises increasing the accuracy of at least one high quality portion of said detected representation by lowering its resolution.

26. A method of measuring quality of a printed image according to claim 25 wherein said close proximity is 5 centimeters or less.

27. A method of measuring quality of a printed image according to claim 25 additionally comprising a step of providing said quality analysis as a feedback to a printing apparatus.

28. A method of measuring quality of a printed image according to claim 25 wherein said steps of measuring and analyzing comprises measuring and analyzing color of said image.

29. A method of measuring quality of a printed image according to claim 28 wherein said step of analyzing color comprises analyzing at least one of a color density and a color registration.

30. A method of measuring quality of a printed image according to claim 28 wherein said step of analyzing color comprising analyzing at least one of Delta-E, delta-LAB and LAB color measurements.

31. A method of measuring quality of a printed image according to claim 27, wherein said step of providing feedback affects composition of printing colors of said printing apparatus.

32. A method of measuring quality of a printed image according to claim 31 wherein said feedback affects at least one of calibration of ink keys and calibration of color registration.

33. A method of measuring quality of a printed image according to claim 25 wherein said step of analyzing comprises comparing said detected representation with a reference image.

34. A method of measuring quality of a printed image according to claim 33 wherein said step of comparing comprises comparing said detected representation with at least one of a computer-generated image and a scanned image.

35. A method of measuring quality of a printed image according to claim 25 wherein said step of analyzing comprises analyzing at least one of a barcode and a text.

36. A method of measuring quality of a printed image according to claim 25 wherein said step of analyzing comprises analyzing at least one of a fixed data and a variable data.

37. A method of measuring quality of a printed image according to claim 25 wherein said step of analyzing comprises displaying said measurement of light.

38. A method of measuring quality of a printed image according to claim 25 additionally comprising sending at least either a measure of light or a measure of quality to a remote site.
